(19) United States
(12) Patent Application Publication
(10) Pub. No.: US 2007/0037566 A1
(43) Pub. Date: Feb. 15, 2007

(54) Prohibiting radio frequency transmissions in a restricted environment

(75) Inventors: Anthony D'Agostino, Smithtown, NY (US); David A. Meyer, Levittown, NY (US); George T. DellaRatta JR., Shirley, NY (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Symbol Technologies, Inc., Holtsville, NY (US)

(21) Appl. No.: 11/204,142

(22) Filed: Aug. 15, 2005

(51) Int. Cl. H04Q 7/20

(52) U.S. Cl. 455/421

(57) ABSTRACT

According to an embodiment is a system that selectively permits or denies access to a restricted environment. Access can be based at least in part on the status of wireless transmitters of a mobile device, the status is one of active or inactive wireless communication. The system can automatically inactivate or disable a transmitter through a wireless command and thereafter permit access to the restricted environment. The mobile device can communicate wirelessly through one of a wireless local-area networks (WLAN), wireless wide-area network (WWAN), wireless personal-area network (WPAN).

### TECHNICAL FIELD

The subject disclosure relates generally to computer systems, and more specifically to mitigating radio frequency transmissions in a restricted or limited access environment.

### BACKGROUND OF THE INVENTION

Wireless mobile technology has become widespread and is utilized for both personal as well as business use. The demand for access to computing power, coupled with the significant decrease in computer size has yielded portable electronics devices, such as handheld computers, which enable users to carry computing resources that previously were limited to relatively fixed, desktop computers. In particular, special-purpose computing and communication devices have been developed, including digital personal assistants, cellular phones, global positioning system receivers, and other electronics devices. Users of portable hand held terminals produce and manage large amounts of data or information, as compared to their respective workload in previous years.

Mobile devices such as telephones, pagers, personal digital assistants (PDAs), data terminals, etc. are designed to be carried by those who travel from place to place in the daily course of business. Each mobile device is capable of communicating with a central system by wireless communications between the mobile device and the central server though an access point to which the mobile device is registered. As the mobile device roams from one cell or geographic area to another, the mobile device will typically disassociate with a particular access point and associate with an access point in the new cell.

Since mobile devices are utilized so extensively a concern has arisen regarding the usage of these devices and the generation of radio frequency (RF) transmissions in areas where such transmissions might damage, disrupt, and/or corrupt other equipment and/or data. A wireless mobile computing device with an active transmitter in close proximity to certain equipment can disrupt operation of that equipment at the loss of significant time, money, and possibly injury to personnel. Thus, there is a need to control when the various transmitters in the device are allowed to be active and to mitigate the usage of transmissions in sensitive environments.

### SUMMARY OF THE INVENTION

The following presents a simplified summary of the invention in order to provide a basic understanding of some aspects of the invention. This summary is not an extensive overview and it is intended to neither identify key or critical elements of the invention nor delineate the scope of the invention. Its sole purpose is to present some concepts of the invention in a simplified form as a prelude to the more detailed description that is presented later.

The invention disclosed and claimed herein, in one aspect thereof, comprises a system for prohibiting radio frequency transmissions in a restricted environment. The system includes an electronic lock that limits user access to a restricted area and a host computer that maintains a register of users and associated mobile devices and selectively allows access to the restricted area based at least in part on a status of the mobile device. Access can be allowed if the user is registered and there are no transmitters active on the mobile device assigned to that user. Access can be denied if at least one transmitter of the mobile device is active or the user is not registered or on the list of users who are authorized to access the area. According to another embodiment, the host computer automatically disables the active wireless transmitter or provides a notification to the user to disable the active transmitter. The mobile device communicates wirelessly through one of a wireless local-area network (WLAN), a wireless wide-area network (WWAN), and a wireless personal-area network (WPAN).

According to another embodiment is a method for selectively allowing access to a restricted area. The method includes maintaining an authorized user list that includes a list of mobile devices registered to each authorized user, receiving a request to access a restricted area, and allowing access to the restricted area based at least in part on the authorized user list and a status of a mobile device on the list. The method can further include ascertaining whether the mobile device is actively connected to the network and allowing access to the restricted area if the device is not actively connected to the network. According to a further embodiment, the method includes automatically disconnecting the device from the network and allowing access to the restricted area.

According to a further embodiment is a computer readable medium having stored thereon computer executable instructions for receiving an access request, associating the received access request with a user and a portable device, and making a determination whether the portable device is transmitting information wirelessly. Access is permitted if there is no transmission of wireless information. The computer readable medium can temporarily deny the access request if the portable device is transmitting information wirelessly using at least one transmitter and/or automatically disable all transmitters on the portable device.

The following description and the annexed drawings set forth in detail certain illustrative aspects of the invention. These aspects are indicative, however, of but a few of the various ways in which the principles of the invention may be employed and the invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an automatic closed loop system that facilitates prohibiting radio frequency transmissions in a restricted environment.

FIG. 2 illustrates a system that selectively allows access to one or more restricted and/or prohibited areas depending on predefined criteria.

FIG. 3 illustrates a system that dynamically accesses user criteria and device status to determine access rights to limited access areas.

FIG. 4 illustrates a system that selectively permits a user of a portable communication device access to a restricted area based upon the status of the portable communication device.

FIG. 5 illustrates a system that provides a plurality of mobile computing device users with limited access to predetermined areas of a facility.

FIG. 6 illustrates a flow chart of a methodology for prohibiting access to a protected environment.

FIG. 7 illustrates a flow chart of a methodology for allowing access or denying access to a restricted area.

FIG. 8 illustrates a flow chart of a methodology that facilitates allowing access to a restricted area after an authorized user is denied entry into a restricted area due to a device being actively connected to a network.

FIG. 9 illustrates a schematic block diagram of a computer operable to execute the disclosed systems and/or methods.

FIG. 10 illustrates an exemplary device operative to execute the systems and/or methods disclosed herein.

FIG. 11 illustrates an exemplary networking environment that can be employed in connection with the invention.

FIG. 12 illustrates an exemplary operating environment that can be employed in connection with the invention.

### DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and devices are shown in block diagram form in order to facilitate describing the invention.

As used in this application, the terms “component,” “module,” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the invention may be implemented as a method, apparatus, or article of manufacture using standard programming and/or engineering techniques to produce software, firmware, hardware, or any combination thereof to control a computer to implement the disclosed invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

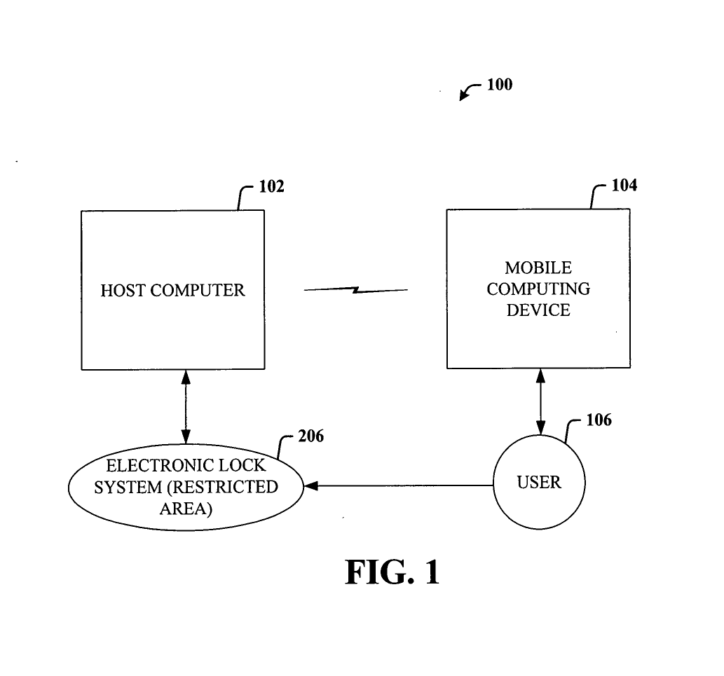

Referring initially to FIG. 1, illustrated is an automatic closed loop system 100 that facilitates prohibiting radio frequency (RF) transmissions in a restricted environment. Restricted environments can include any area, environment, or place in which access is limited and where RF transmissions can disrupt operation of equipment located in the area. These restricted areas can be found, for example, in hospitals (e.g., intensive care ward, cardiac ward, operating rooms, . . . ) and areas that might contain sensitive medical equipment (e.g., pacemakers, defibrillators, heart monitors, . . . ). The disruption of such equipment could lead to personal injury or the loss of life. Other examples where access might be limited include, for example, a telephone switching facility that includes areas that contain a variety of electronic equipment that are particularly susceptible to RF transmissions.

The system includes a host computer 102 that interfaces wirelessly with a mobile computing device 104 associated with a user 106. The host computer can also be connected, either wirelessly or through a physical hardwired connection, to a panel or electronic lock system 108 located near the restricted area through which the user 106 requests access to the restricted area. The user 106 can enter information relating to such user through utilizing of various devices such as a mouse, a roller ball, a keypad, a keyboard, a pen and/or voice activation, for example, associated with the electronic lock system 108. The host computer 102 is configured to determine whether the user 106 has the required access level to disable the electronic lock system 108 and gain access to the restricted area. Host computer 102 is configured to selectively prohibit and/or allow access to certain restricted or limited access area(s) based upon various factors including the condition or activity status of the wireless computing device 104. The activity status of the mobile computing device 104 can be whether it is actively connected to the network or disconnected from the network (e.g., not logged on, wireless connections not active, . . . ). For example, the host computer 102 can allow access to a particular area depending on a user credential, a user access level, a user permission, and/or the condition of the device (e.g., actively connected to network).

Mobile computing device 104 can be a plurality of mobile or wireless devices, including a personal digital assistant (PDA), a mobile phone, a smart phone, a palm pilot, a personal data assistant, a mobile computer, a bar code scanner, an RFID device, a laptop computer, a wearable computer device, or other mobile computing devices. Mobile device 104 can facilitate RF transmissions including transmissions on a wireless local-area network (WLAN), a wireless wide-area network (WWAN), a wireless personal-area network (WPAN), etc. Each mobile device 104 is associated with a user 106 that has registered the device 104 on a network. The mobile computing device 104 and the host computer 102 are operative to communicate wirelessly or through a wired or physical connection. It should be understood that while one mobile computing device 104 and one user 106 are shown, there can be more than one of each. In addition, a user 106 can be associated with more than one mobile computing device 104. It is also to be understood that more than one electronic lock system 108 can be utilized with the systems and/or methods disclosed herein.

The mobile device(s) 104 can be volatile memory(s) device or nonvolatile memory device(s). Volatile refers to memory that is not permanent and which is erased when the device is powered down (e.g., turned off, cold booted). Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). Suitable nonvolatile memory can include read only memory (ROM), programmable ROM (PROM), electrically programmable ROM (EPROM), electrically erasable programmable ROM (EEPROM), or flash memory.

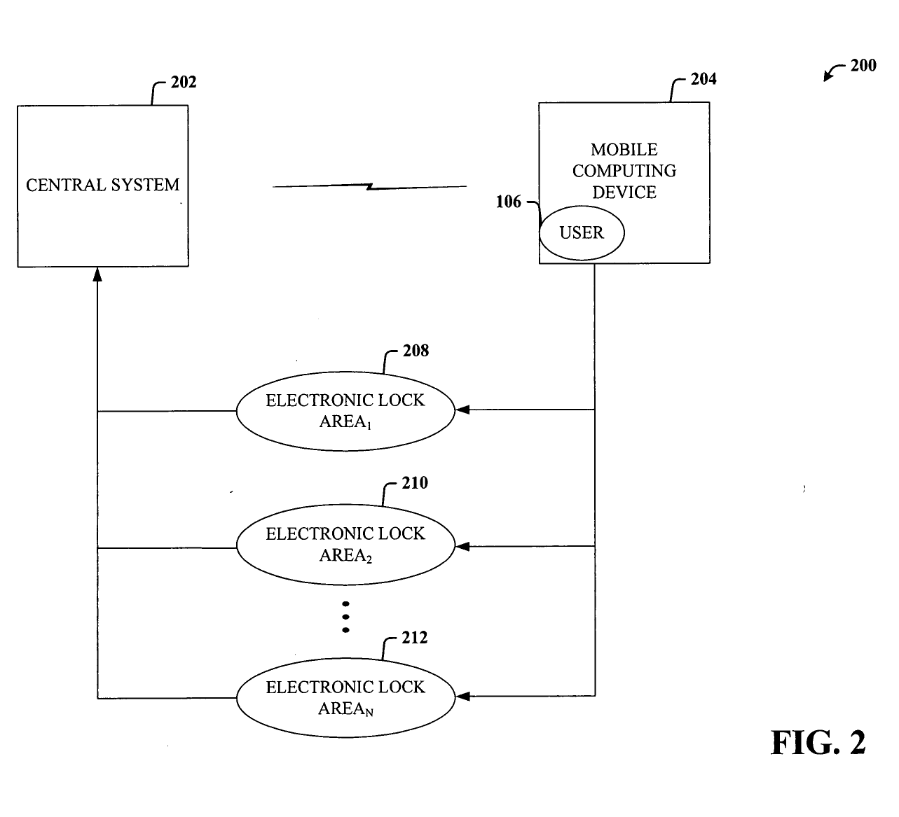

With reference now to FIG. 2, illustrated is a system 200 for selectively allowing access to one or more restricted and/or prohibited areas depending on predefined criteria. System 200 includes a central system 202 and a mobile computing device 204. Central system 202 selectively allows a user 206 and associated mobile device 204 access to a plurality of areas the access to which is controlled by an electronic lock, for 210, and Electronic Lock Area_{N} 212, where N is an integer equal to or greater than one. The areas 208, 210, 212 can have limited access due to a wide variety of reasons, such as areas that include equipment that is sensitive to RF transmissions, life saving/maintaining equipment, hazardous material(s), confidential information, chemicals, etc. Some areas may be sensitive to RF transmissions while others are not and such transmissions can occur in those areas without disrupting or affecting equipment. It is to be understood that the areas that are not sensitive to RF transmissions may not require transmitters of mobile devices to be turned off or disabled prior to entry into such areas.

The central system 202 can include a listing, such as an access control list (ACL), that includes a listing of registered users on the central system 202 network and the access level of the registered users for each restricted area 208, 210, 212. For example, a first user can have access to none of the restricted areas. A second user can have access to one restricted area, such as 208, and a third user has access to area 210. A fourth user may have unlimited access to all areas 208, 210, 212. The central system 202 maintains the listing of users and respective accessible areas. Updates to such a listing are dynamic and can be updated as needed. Also maintained by the central system 202 is a listing of mobile devices 204 associated with each registered user 206.

The central system 202 interfaces with the electronic lock area 208, 210, 212 through various user interfaces, such as an input panel. The user 206 enters information regarding such user in the input panel. The central system 202 and electronic lock area 208, 210, 212 can communicate through wireless or wired communication. When a user 206 desires access to a restricted area 208, 210, 212, the user requests such access by, for example, entering a personal identification number PIN, an access code, swiping an access card, fingerprint, eye print, speech recognition, etc. The means of accessing the restricted or prohibited area can be any technology and all such technologies work equally well with the systems and/or methods disclosed herein.

When access is requested, the central system 202 can search or perform a look-up of a registered user/access level listing and a mobile device listing. It is to be understood that the listing or registry can be the same or separate listings. The central system 202 can determine if the user 206 has the proper privilege level to enter the requested area. The central system 202 can determine whether RF transmissions are restricted in the particular area, and, if so, a determination can be made whether the mobile device 204 is actively connected to the network. If it is not actively connected, immediate access to the area can be allowed for authorized users. If the mobile device is actively connected, access to the area can be denied until such time as the mobile device 206 is no longer actively connected to the network.

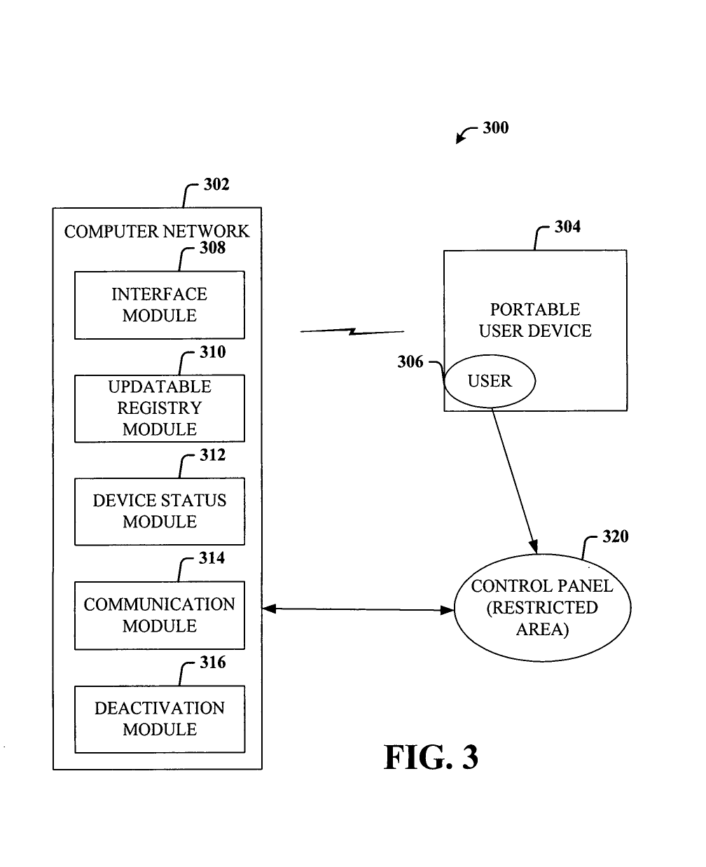

FIG. 3 illustrates a system 300 that dynamically accesses user criteria and device status to determine access rights to limited access areas. System 300 includes a computer 302, such as a computer network, that interfaces with a user 306 either directly or through a portable user device 304. The computer network 302 can include modules that facilitate accessing user criteria and a status of the portable user device. The included modules can be an interface module 308, an updatable registry module 310, a device status module 312, a communication module 314, and/or a deactivation module 316. It should be understood that these modules are for illustration purposes and more modules or less modules may be utilized with computer network 302 to dynamically access user criteria and device status according to the systems and/or methods disclosed herein. It is also to be understood that the various modules 308, 310, 312, 314, 316 can be located remote from the computer network 102 and communicate through a wired or a wireless connection.

The interface module 308 is configured to receive a user input from, for example, a control panel 320 located at an entry point to a limited access area. The control panel 320 can be hardwired to the computer network 302 or the communication can be facilitated through wireless communication. It is to be appreciated that the computer network 302 and control panel 320 can be located in different areas, buildings, etc. A user 306 can input information in the control panel 320 that identifies such user (e.g., pin, access card, . . . ).

The interface module 308 receives the user information and transmits it to an updatable registry module 310. The updatable registry module 310 is configured to receive and maintain a listing or registry of users associated with a computer network, for example. The updatable registry module 310 can be manually updated, through a user interaction, such as by a system administrator that assigns a user identification and/or access rights to the various users of the computer network 302. The updatable registry module 310 can also associate a user 306 with a portable user device 304, if such user has a portable user device.

For some restricted areas, RF transmissions may be undesirable and the device status module 312 can determine the status of the portable user device 304. The status of the portable device 304 includes whether the device is actively connected to the network or disconnected. This status determination is utilized when a user 306, associated with the portable device 304, requests access to a restricted area in which the mitigation of RF transmissions is desired. The status of the portable user device 304 can be determined regardless of the location of the device. For example, a user 306 may place the device on their desk and leave it there while the user 304 moves to a limited access area. If the area is one in which devices should not be actively connected to the network, and the device left on the desk is actively connected, access to the area is denied until the device is no longer active, even though the device is not in the vicinity of the restricted area.

Alternatively or in addition, the device status module 312 can determine the location of the registered device and/or can work in conjunction with a location module, for example, to facilitate such a determination. When a device registered to a user is not in close proximity to the restricted area, the user can be granted access to the restricted area without requiring the device to be disconnected from the network. For example, the restricted area can be located or associated with an access point of a particular cell or geographic area. If the device is attached or in communication with an access point of a different cell when the user attempts to gain entry into the restricted area, the device status module 312 can determine that the device poses no threat to the restricted area and can allow the user immediate access. The location of such device can also be facilitated through other locating systems (e.g., Global Positioning System (GPS), . . . ) and all such alterations and/or modifications all intended to fall within the scope of the subject disclosure.

If the device is active and should be disconnected from the network, the communication module 314 can communicate such status to the user 306. The communication module 314 can send the user 314 a message (e.g., text message, email, voice message, . . . ) notifying such user of the device status and that the device must be disconnected from the network before access to the requested area is allowed. If the user receives the transmitted message from the communication module 314, the user knows the action(s) to take to access the area and the RF transmitters of the device can be manually disabled. However, if the user refuses to take such steps or does not receive the message (e.g., the device is at a different location than the user), the RF transmitters can be automatically disabled by the deactivation module 316.

The deactivation module 316 can automatically disable the RF transmitters by sending a wireless signal or command to the device 304. This signal can be sent immediately when access to a restricted area is requested or after waiting a length of time for the device RF transmitters to be deactivated, or after a predetermined number of notices to the user has been sent by the communication module 314. Once the RF transmitters are disabled, either manually or automatically, access to the restricted area can be allowed, either automatically or once the user has requested access to the area again.

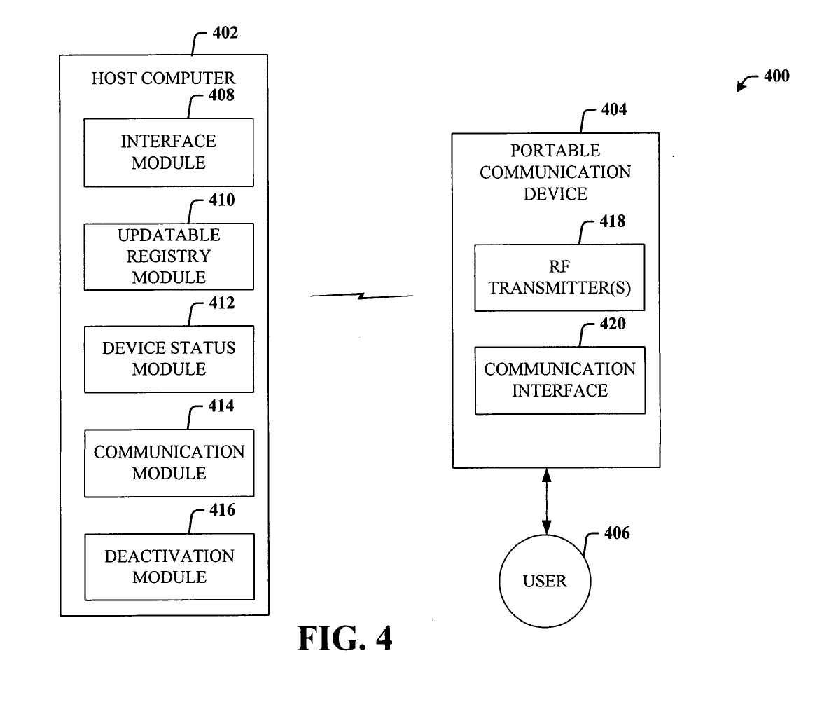

Referring now to FIG. 4 illustrated is a system 400 that selectively permits a user of a portable communication device access to a restricted area based upon the status of the portable communication device. System includes a host computer 402 and at least one portable communication device 404. Host computer 402 includes an interface module 408, updatable registry module 410, a portable device status module 412, a communication module 414, and/or a deactivation module 416. These modules operate in a similar fashion as those illustrated and discussed with reference to the computer network 302 of FIG. 3 and will not be discussed further.

The host computer 402 communicates wirelessly with portable communication device 404. A user 406 is associated with portable communication device 404 and can interface with both the device 404 and the host computer 402. Portable communication device 404 includes one or more RF transmitter(s) 418 and a communication interface 420.

RF transmitter(s) 418 facilitates wireless communication to/from portable communication device 404 through any wireless means. For example, RF transmitter(s) 418 can facilitate communication to a plurality of networks (e.g., WLAN, WWAN, WPAN, . . . ) allowing user 406 to communicate with host computer 402 and other users located within the range of the RF transmitter(s). RF transmitter(s) 418 can send status information to host computer 402. Alternatively or in addition, host computer 402 can request, obtain, or actively search for status of RF transmitter(s) 418 of a portable communication device 404. The RF transmitter(s) can be selectively enable or disabled depending on the user's requirements. It is also to be appreciated that the host computer 402 can autonomous disable each RF transmitter(s) to allow user 406 access to a limited access area in which RF communication is prohibited.

Portable communication device 404 also includes a communication interface 420, which can be a display, a tone, a vibration means, or other means to alert a user 406 that information is available for such user 406. The communication interface 420 can receive a wireless communication from a communication module 414 of host computer 402 that includes a notice that the RF transmitter(s) of portable communication device 404 are active and should be deactivated for the user to obtain requested access to a limited access area.

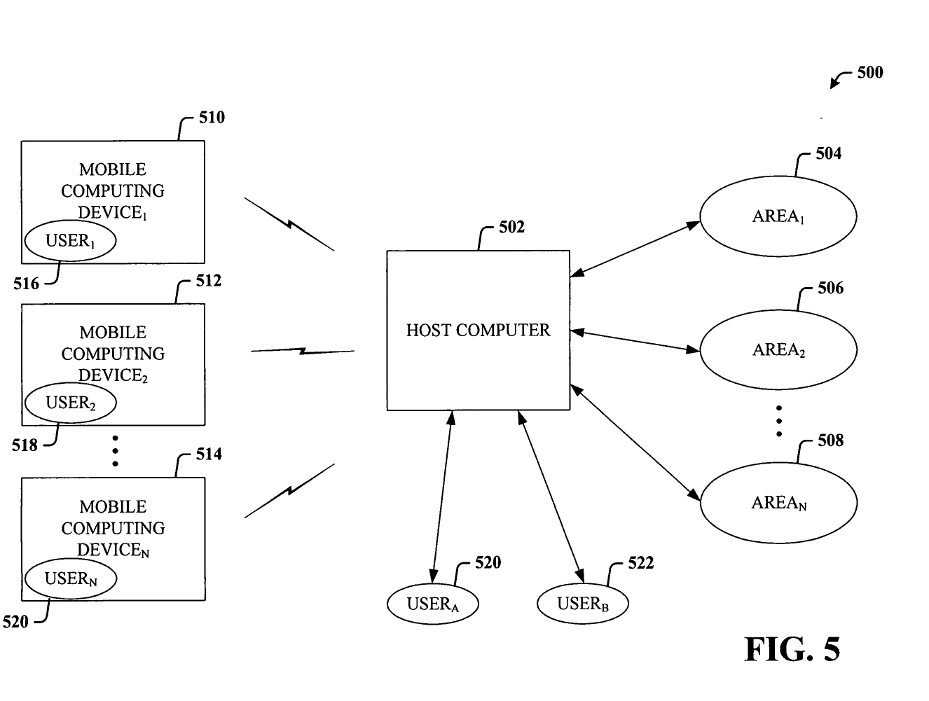

FIG. 5 illustrates a system 500 that provides a plurality of mobile device users with limited access to predetermined areas of a facility. System 500 includes a host computer 502 that can be a central system of a facility. Host computer 502 can be hardwired to a plurality of areas within the facility to which access by personnel is restricted based upon predefined criteria. These areas are labeled Area₁ 504, Area₂ 506 and Area_{N} 508, where N is an integer equal to or greater than one. It is to be understood that host computer 502 can be hardwired, as shown, to a control panel, an access panel, a computer, or electronic locks located adjacent to each limited-access area 504, 506, 508. Alternatively, host computer 502 can communicate wirelessly to the control panel, access panel, computer, or electronic locks.

Host computer 502 can also interface with a plurality of mobile computing devices, labeled Device₁ 510, Device₂ 512, and Device_{N} 514, where N is an integer greater than or equal to one. The mobile computing devices 510, 512, 514 are associated with respective users 516, 518, 520. It is to be appreciated that users 516, 518, 520 are authorized to access host computer 502 and such devices 510, 512, 514 are registered on host computer 502. Host computer 502 is configured to maintain a listing of users 516, 518, 520 that can have access to one or more limited-access areas 504, 506, 508. It is also to be understood that users 516, 518, 520 may not have access to areas 504, 506, 508. In addition, a plurality of users not associated with mobile computing devices can be registered on host computer 502 and can have access to restricted areas 504, 506, 508. A representation of such users are labeled as User_{A} 522 and User_{B} 524.

When a user 516, 518, 520, 522, 524 requests access to a limited-access area 504, 506, 508 through a plurality of access means, host computer 502 selectively determines if access should be allowed or denied to such user 516, 518, 520, 522, 524. Host computer 502 can include a dynamically updatable listing of each user 516, 518, 520, 522, 524 and access privileges, rights, etc. as assigned by, for example, system administrators, security personnel, etc. Host computer 502 can also maintain an accessible listing of limited-access areas 504, 506, 508 that includes information regarding such areas including if RF transmissions should be prohibited before access to the area 504, 506, 508 is permissible. Host computer 502 accesses both listings and determines if a user 516, 518, 520, 522, 524 can access the requested area 504, 506, 508.

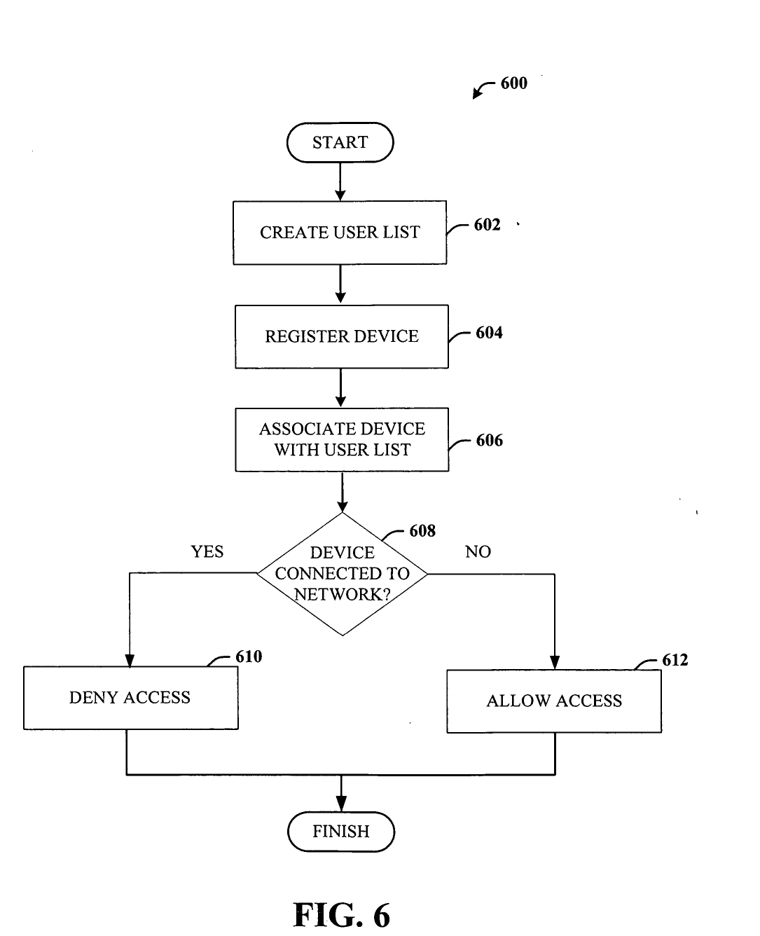

Referring to FIGS. 6-8, methodologies relating to selectively permitting access to restricted areas are illustrated. While, for purposes of simplicity of explanation, the methodologies are shown and described as a series of acts, it is to be understood and appreciated that the methodologies are not limited by the order of acts, as some acts may, in accordance with these methodologies, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement the following methodologies.

Throughout a facility (e.g., hospital, telephone company, internet service provider, . . . ) there may be locations or divisions in which access to a particular area is limited to specific users and, in addition, wherein the elimination of RF transmissions is desired. Such limited access areas are generally physically enclosed with walls and doors allowing control of authorized access. Access to these areas is typically through an electronic locking mechanism at each door. Entry through these locking systems usually requires a key code, magnetic stripe badge, barcode badge, RFID module embedded in the badge, etc. This existing system allows for the control and monitoring of authorized personnel in these areas. Electronic locks typically allow entry based on an access control list (ACL). An ACL is maintained and updated generally through a wired network connection back to a host computer system. Updates to an ACL can be quickly and easily accommodated. When a user enters the defined restricted area, it may be desirable that wireless communication devices are inactive so that equipment within the restricted area are not disturbed by communication received from/to such mobile computing devices. The systems and/or methods disclosed herein can utilize the existing infrastructure of electronic locks in combination with permission levels and association of user(s) with mobile computing device(s). By requiring the user to disable the active transmitters on their assigned wireless mobile computing device, such users will be denied entry into these restricted areas until the action of disabling the transmitters is accomplished.

FIG. 6 illustrates a flow chart of a methodology 600 for prohibiting access to a protected environment. The method starts at 602 where a listing of users, such as an access control list (ACL), is created and/or updated with an identification of users authorized to enter such restricted area. A listing of devices registered to each user is created at 604. It is to be understood that some users on the ACL listing may not be associated with a mobile device at 604.

When access to a restricted area is attempted, the user is associated with a registered device at 606. If there is such an association between a user and a registered device, a determination is made, at 608, whether the device is actively connected to the network. The device does not have to be in the user's possession at the time of this determination and could be remote from the user (and limited access area). If the device is actively connected “yes,” access to the restricted area is denied at 610. If the determination at 608 is “no,” then the device is not actively connected to the network and access to the restricted area is allowed at 612.

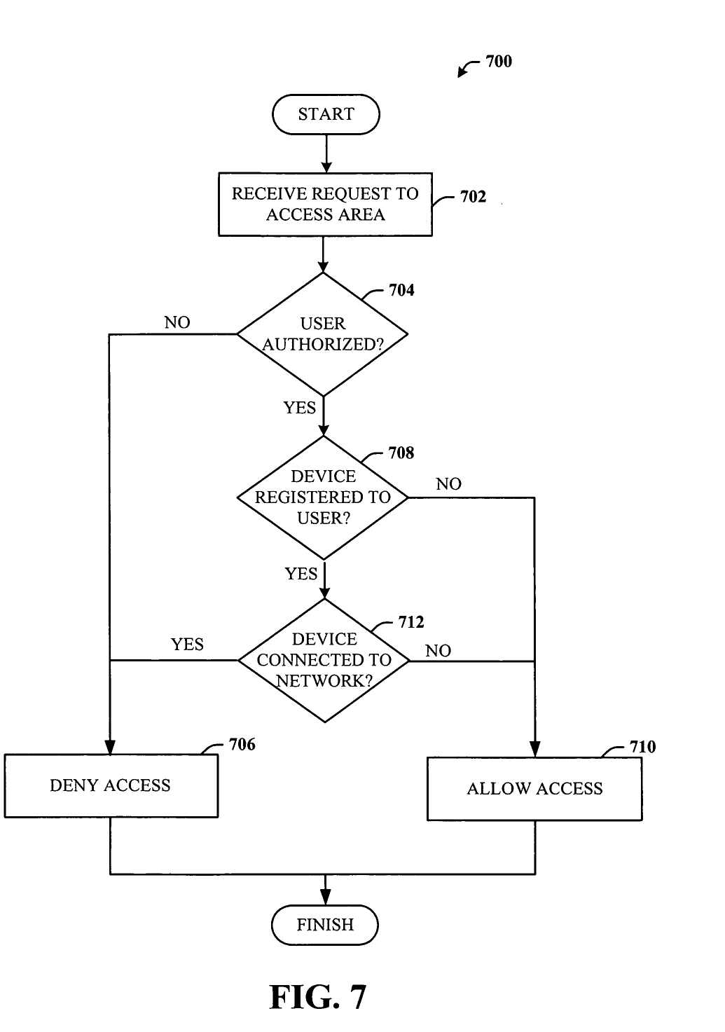

FIG. 7 illustrates a flow chart of a methodology 700 for allowing or denying access to a restricted area. The method starts at 702 where a request to access a restricted area is received from a user through a plurality of user identification systems, such as an electric lock system. At 704, an initial determination is made whether the user is authorized to access the area. If the determination is “no,” the user is not authorized and access is denied at 706. If the determination at 704 is “yes,” the user is authorized to access the area.

The method continues, at 708, where a determination is made whether the user has a registered device that should have its RF transmitters deactivated prior to such user entering the restricted area. If it is determined that the user does not have a device registered (“no”) the user is allowed access at 710. If the user does have a registered device (“yes”), at 712 a determination is made whether that device is actively connected to the network. If the determination at 712 is “no,” the device is not actively connected and access is allowed at 710. If the determination is “yes,” the device is actively connected and access to the restricted area is denied at 706. The user can attempt such access again after the device is no longer actively connected to the network.

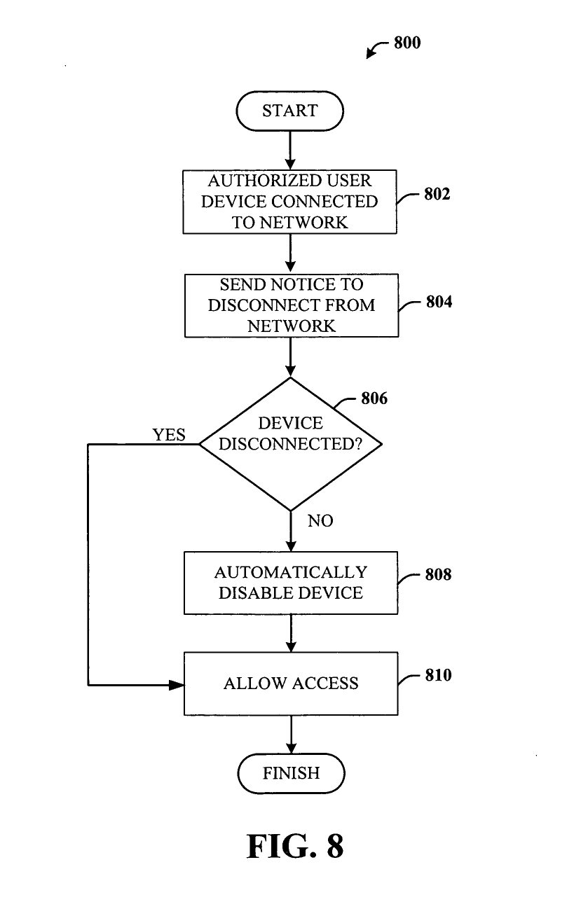

FIG. 8 illustrates a flow chart of a methodology 800 that facilitates allowing access to a restricted area after an authorized user is denied entry into a restricted area because a device is actively connected to a network. The method beings, at 802, when an authorized user with an active device requests access to a restricted area. The active device is acknowledged and, at 804, the user is sent a notice to remove the device from the network before access to the area is allowed. This notice can be a text message or other means to notify such user of the status of the device and why access to the area has been denied.

At 806, a determination is made whether the device is no longer active on the server. If “no,” it indicates that the device has been taken off-line (e.g., user has turned off device) and access to the area is allowed at 810. If the determination at 806 is “yes,” the device has not been disconnected from the network. This can occur in situations where the device is at a location different from the user (and restricted area). For example, the user may leave the device on such user's desk and walk to the restricted area. Rather than requiring the user to retrieve the device from a remote location, the method can automatically disable or disconnect the RF transmitters of the device, at 808. It is to be understood that rather than immediately performing the automatic disconnection at 808, the method can return to 804 and send a further notice to the user. After a predetermined number of attempts to notify the user, or after a certain time, the method can automatically disable the device at 808. After the device is disabled, access to the restricted area is allowed at 810.

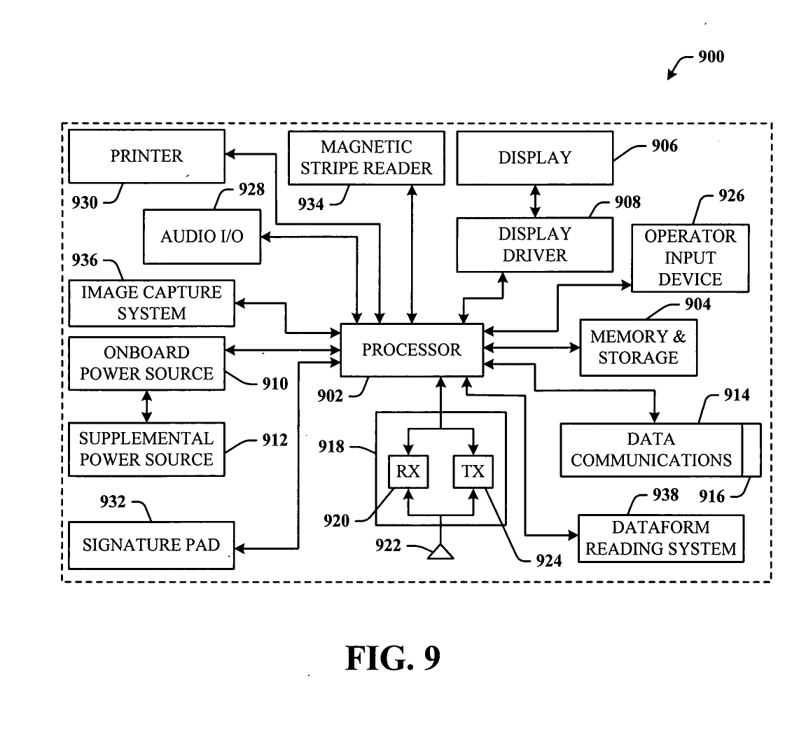

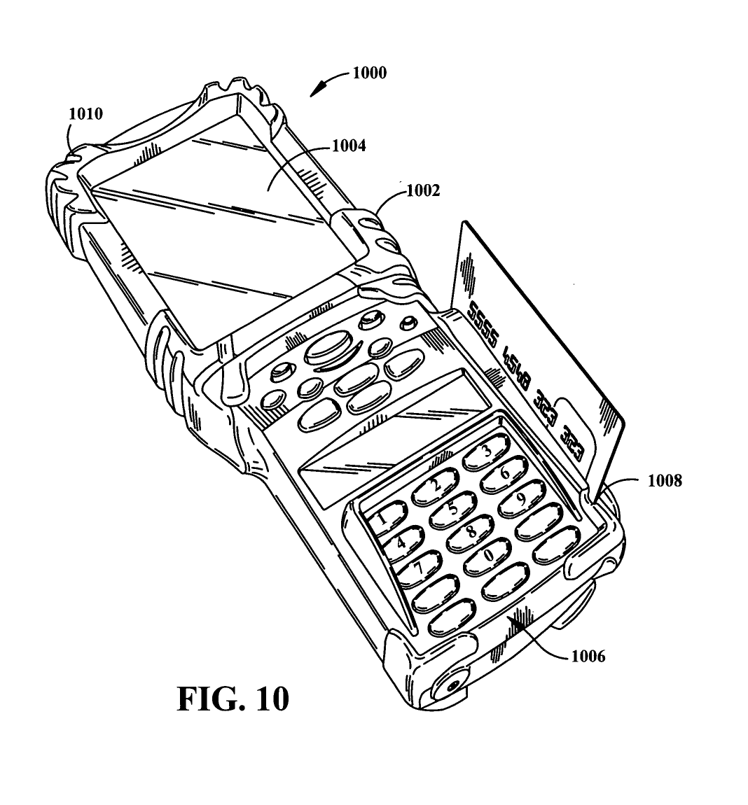

Referring now to FIG. 9, illustrated is a schematic block diagram of a portable hand-held terminal device 900 (similar to the portable scanning device 1000 as illustrated in FIG. 10) according to one aspect of the invention, in which a processor 902 is responsible for controlling the general operation of the device 900. The processor 902 is programmed to control and operate the various components within the device 900 in order to carry out the various functions described herein. The processor 902 can be any of a plurality of suitable processors. The manner in which the processor 902 can be programmed to carry out the functions relating to the invention will be readily apparent to those having ordinary skill in the art based on the description provided herein.

A memory 904 connected to the processor 902 serves to store program code executed by the processor 902, and serves as a storage means for storing information such as user credential and receipt transaction information and the like. The memory 904 can be a nonvolatile memory suitably adapted to store at least a complete set of the information that is displayed. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information, and the processor 902 could include a program for alternating or cycling between various sets of display information.

A display 906 is coupled to the processor 902 via a display driver system 908. The display 906 can be a color liquid crystal display (LCD), plasma display, or the like. In this example, the display 906 is a ¼ VGA display with sixteen levels of gray scale. The display 906 functions to present data, graphics, or other information content. For example, the display 906 can display a set of customer information, which is displayed to the operator and can be transmitted over a system backbone (not shown). Additionally, the display 906 can display a variety of functions that control the execution of the device 900. The display 906 is capable of displaying both alphanumeric and graphical characters.

Power is provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 and to charge the onboard power system 910. The processor 902 of the device 900 induces a sleep mode to reduce the current draw upon detection of an anticipated power failure.

The terminal 900 includes a communication subsystem 914 that includes a data communication port 916, which is employed to interface the processor 902 with a remote computer. The port 916 can include at least one of Universal Serial Bus (USB) and IEEE 1394 serial communications capabilities. Other technologies can also be included, for example, infrared communication utilizing an infrared data port.

The device 900 can also include a radio frequency (RF) transceiver section 918 in operative communication with the processor 902. The RF section 918 includes an RF receiver 920, which receives RF signals from a remote device via an antenna 922 and demodulates the signal to obtain digital information modulated therein. The RF section 918 also includes an RF transmitter 924 for transmitting information to a remote device, for example, in response to manual user input via a user input device 926 (e.g., a keypad) or automatically in response to the completion of a transaction or other predetermined and programmed criteria. The transceiver section 918 facilitates communication with a transponder system, for example, either passive or active, that is in use with product or item RF tags. The processor 902 signals (or pulses) the remote transponder system via the transceiver 918, and detects the return signal in order to read the contents of the tag memory. In one implementation, the RF section 918 further facilitates telephone communications using the device 900. In furtherance thereof, an audio I/O section 928 is provided as controlled by the processor 902 to process voice input from a microphone (or similar audio input device) and audio output signals (from a speaker or similar audio output device). In another implementation, the device 900 can provide voice recognition capabilities such that when the device 900 is used simply as a voice recorder, the processor 902 can facilitate high-speed conversion of the voice signals into text content for local editing and review, and/or later download to a remote system, such as a computer word processor. Similarly, the converted voice signals can be used to control the device 900 instead of using manual entry via the keypad 926.

Onboard peripheral devices, such as a printer 930, signature pad 932, and a magnetic strip reader 934 can also be provided within the housing of the device 900 or accommodated externally through one or more of the external port interfaces 916.

The device 900 can also include an image capture system 936 such that the user can record images and/or short movies for storage by the device 900 and presentation by the display 906. Additionally, a dataform reading system 938 is included for scanning dataforms. It is to be appreciated that these imaging systems (936 and 938) can be a single system capable of performing both functions.

FIG. 10 is provided to assist in understanding and to provide context to an embodiment of the invention. Specifically, FIG. 10 illustrates an example of a handheld terminal 1000 operative to execute the systems and/or methods disclosed herein. It is to be understood that the handheld terminal shown and described is merely exemplary and other devices can be utilized in accordance with the subject disclosure.

The handheld terminal 1000 can include a housing 1002 which can be constructed from a high strength plastic, metal, or any other suitable material. The handheld terminal 1000 can also include a display 1004. As is conventional, the display 1004 functions to display data or other information relating to ordinary operation of the handheld terminal 1000 and/or mobile companion (not shown). For example, software operating on the handheld terminal 1000 and/or mobile companion can provide for the display of various information requested by the user. Additionally, the display 1004 can display a variety of functions that are executable by the handheld terminal 1000 and/or one or more mobile companions. The display 1004 can provide for graphics based alphanumerical information such as, for example, the price of an item requested by the user. The display 1004 can also provide for the display of graphics such as icons representative of particular menu items, for example. The display 1004 can also be a touch screen, which can employ capacitive, resistive touch, infrared, surface acoustic wave, or grounded acoustic wave technology.

The handheld terminal 1000 can further include user input keys 1006 for allowing a user to input information and/or operational commands. The user input keys 1006 can include a full alphanumeric keypad, function keys, enter keys, etc. The handheld terminal 1000 can also include a magnetic strip reader 1008 or other data capture mechanism (not shown). An electronic signature apparatus can also be employed in connection with the magnetic strip reader or a telecheck system.

The handheld terminal 1000 can also include a window 1010 in which a bar code reader/bar coding imager is able to read a bar code label, or the like, presented to the handheld terminal 1000. The handheld terminal 1000 can include a light emitting diode (LED) (not shown) that is illuminated to reflect whether the bar code has been properly or improperly read. Alternatively, or additionally, a sound can be emitted from a speaker (not shown) to alert the user that the bar code has been successfully imaged and decoded. The handheld terminal 1000 can also include an antenna (not shown) for wireless communication with a radio frequency (RF) access point; and an infrared (IR) transceiver (not shown) for communication with an IR access point.

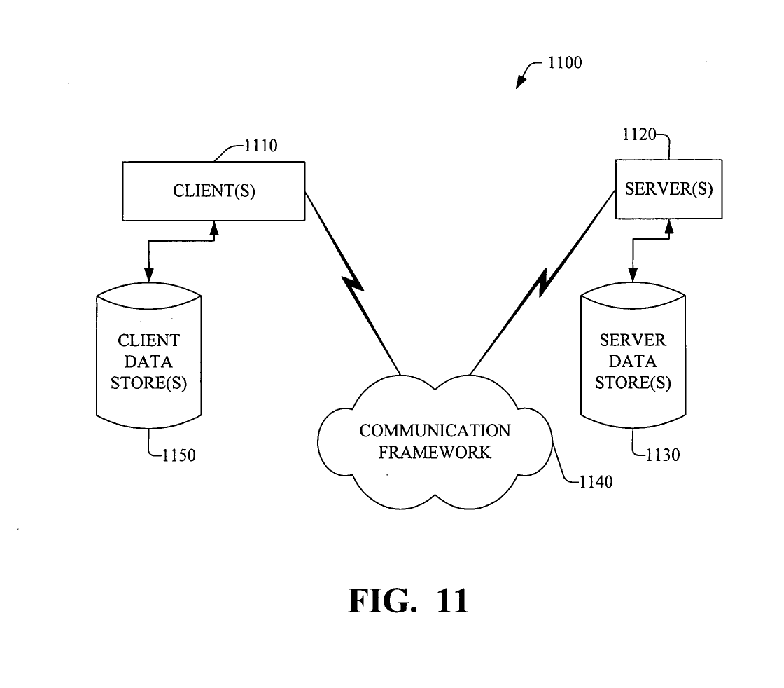

FIG. 11 is a schematic block diagram of a sample-computing environment 1100 with which the invention can interact. The system 1100 includes one or more client(s) 1110. The client(s) 1110 can be hardware and/or software (e.g., threads, processes, computing devices). The system 1100 also includes one or more server(s) 1120. The server(s) 1120 can also be hardware and/or software (e.g., threads, processes, computing devices). The servers 1120 can house threads to perform transformations by employing the invention, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1140.

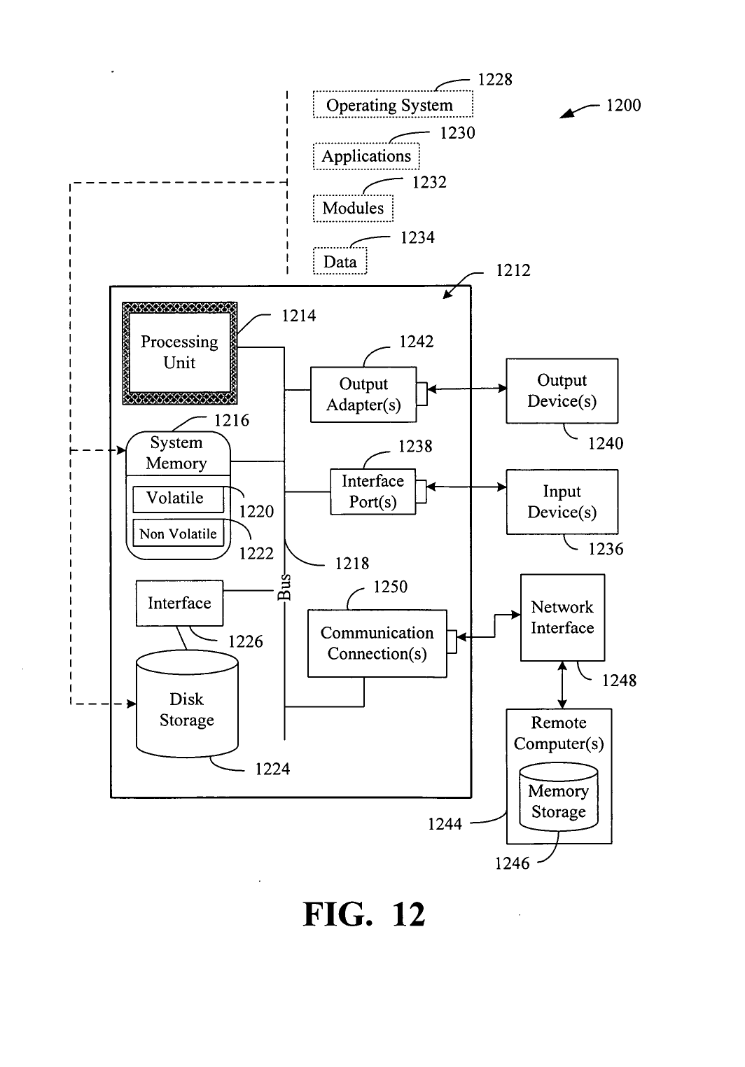

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212 and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for prohibiting radio frequency transmissions in a restricted environment, comprising
an electronic lock that limits user access to a restricted area; and
a host computer that maintains a register of users and associated mobile devices and selectively allows access to the restricted area based at least in part on a status of a mobile device.

2. The system of claim 1, the host computer allows access to the restricted area if the user is registered and there are no transmitters active on the mobile device.

3. The system of claim 1, the host computer denies access to the restricted area if at least one transmitter of the mobile device is active or the user is not registered.

4. The system of claim 3, the host computer automatically disables one or more transmitters in the device.

5. The system of claim 3, the host computer provides a notification to the user to disable the at least one active transmitter.

6. The system of claim 1, the mobile device communicates wirelessly through one of a wireless local-area networks (WLAN), wireless wide-area network (WWAN), and wireless personal-area network (WPAN).

7. The system of claim 1, the host computer selectively allows access utilizing the electronic lock.

8. A computer readable medium having stored thereon the components of the system of claim 1.

9. A method for selectively allowing access to a restricted area, comprising:
maintaining an authorized user list that includes a mobile device registered to each authorized user;
receiving a request to access a restricted area; and
allowing access to the restricted area based at least in part on the authorized user list and a status of the registered mobile device.

10. The method of claim 9, further comprising:
ascertaining if the mobile device is actively connected to the network; and
allowing access to the restricted area if the device is not actively connected to the network.

11. The method of claim 10, further comprising:
denying access to the restricted area if the device is actively connected to the network.

12. The method of claim 11, further comprising:
automatically disconnecting the device from the network; and
allowing access to the restricted area.

13. The method of claim 11, further comprising:
notifying the user to disconnect the device from the network; and
allowing access to the restricted area when the device is disconnected from the network.

14. A system that selectively prohibits access to restricted environments, comprising:
means for receiving a user request to access a restricted environment,
means for ascertaining if the user has the proper authorization level;
means for associating a portable communication device with the user; and
means for selectively prohibiting access to the restricted environment.

15. The system of claim 14, further comprising:
means for ascertaining if the portable communication device is actively communicating wireless data.

16. The system of claim 15, further comprising:
means for automatically disabling a transmitter of the portable device if there is active wireless communication.

17. The system of claim 16, further comprising:
means for allowing access to the restricted environment once the transmitter is disabled.

18. A computer readable medium having stored thereon the components of the system of claim 14.

19. A computer readable medium having stored thereon computer executable instructions for:
receiving an access request;
associating the received access request with a user and a portable device;
making a determination whether the portable device is transmitting information wirelessly; and
permitting access if there is there is no transmission of wireless information.

20. The computer-readable medium of claim 19, further comprising computer-executable instructions for:
temporarily denying the access request if the portable device is transmitting information wirelessly using at least one transmitter; and
automatically disabling the at least one transmitter on the portable device.
